(19) United States
(12) Patent Application Publication
(10) Pub. No.: US 2026/0021664 A1
(43) Pub. Date: Jan. 22, 2026

(54) Ink Stack and Printing Device

(71) Applicant: Shenzhen Anker Smart Technology Co., Ltd., Shenzhen (CN)

(72) Inventor: Qingxu Qian, Shenzhen (CN)

(21) Appl. No.: 19/275,051

(22) Filed: Jul. 21, 2025

(30) Foreign Application Priority Data
Jul. 22, 2024 (CN) 202421742323.3

(51) Int. Cl. B41J 2/175; B41J 2/165

(52) U.S. Cl. CPC B41J 2/17596; B41J 2/16523; B41J 2/16535

(57) ABSTRACT

An ink stack and a printing device are disclosed. The ink stack may comprise an ink pad assembly, a maintenance base, an air pump, and/or a vent tube. The ink pad assembly may have an adsorption groove for adsorbing a nozzle. The ink pad assembly is mounted on the maintenance base. The air pump may be connected to the adsorption groove through an exhaust tube. The vent tube may be connected to the exhaust tube, and the vent tube may be used to connect the exhaust tube with the atmosphere. The ink pad assembly may be used to adsorb the nozzle, and the vent tube may be used to relieve pressure from the adsorption groove, thereby controlling the force on the nozzle and reducing the possibility of damage to the nozzle due to excessive adsorption pressure or pressure changes.

### CROSS REFERENCE TO RELATED APPLICATION

The present application claims priority to Chinese Patent Application No. 202421742323.3, filed on Jul. 22, 2024, which is herein incorporated by reference by its entirety.

### TECHNICAL FIELD

The present application relates to the technical field of printing devices, in particular to an ink stack and a printing device.

### BACKGROUND

An ink stack of a printing device may provide moisture retention and protection for a nozzle. A negative pressure device might be connected to the ink stack, and the negative pressure device may be used to form a negative pressure environment at a preset position of the ink stack. When the nozzle reaches the preset position of the ink stack, the negative pressure device may be configured to suck away ink or other dirt on the nozzle, which may reduce the possibility of blockage caused by ink coagulation on the surface of the nozzle. When the negative pressure device operates, the nozzle might be prone to damage due to unstable negative pressure suction or excessive adsorption force.

### SUMMARY

Aspects described herein relate to an ink stack and a printing device, such as might avoid damage by the ink stack to a nozzle.

For instance, aspects described herein relate to an ink stack used for a printing device, the printing device comprising a nozzle, where the ink stack may comprise: a maintenance base and/or an ink pad assembly mounted on the maintenance base. The ink pad assembly may have an adsorption groove, and the adsorption groove may be used to adsorb the nozzle. The device may further comprise an air pump connected to the adsorption groove through an exhaust tube. The device may further comprise a vent tube, connected to the exhaust tube, used to connect the exhaust tube with the atmosphere.

The ink pad assembly may be used to adsorb the nozzle, and the vent tube may be used to relieve pressure from the adsorption groove, thereby controlling the force on the nozzle and reducing the possibility of damage to the nozzle due to excessive adsorption pressure or pressure changes.

The ink stack may further comprise: a main control board, electrically connected to the air pump, where the main control board may be used to obtain working signals of the air pump; and an air-tight member, where the air-tight member may be used to control the opening or closing of the vent tube, the air-tight member may be electrically connected to the main control board, and the main control board may be also used to control the work of the air-tight member based on the working signals of the air pump.

The air-tight member may comprise: a plug, where the plug may have an open position and a closed position, the open position may be used for opening the vent tube, and the closed position may be used for closing the vent tube; and a first driving assembly, connected to the plug, where the main control board may be electrically connected to the first driving assembly, and the main control board may be used to control the movement of the first driving assembly, so as to drive the plug to move between the open position and the closed position.

The ink stack further may comprise: a scraper assembly, where the scraper assembly may have a first position and a second position, and the scraper assembly may be movably connected to the ink pad assembly between the first position and the second position; and/or a second connector, connected to the scraper assembly, where an output end of the first driving assembly may be connected to the second connector in a driving manner, and the first driving assembly may be also used to drive the second connector to move the scraper assembly between the first position and the second position.

The first driving assembly may be used to drive the scraper assembly to move from the second position to the first position. The ink stack may further include: a first reset member, with one end connected to the ink pad assembly and the other end connected to the second connector or the scraper assembly, where the first reset member may be used to generate a force, and the force may enable the scraper assembly to move from the first position to the second position.

The ink pad assembly may be at least partially arranged on one side of the maintenance base along a first direction, the adsorption groove may be located on one side of the ink pad assembly away from the maintenance base along the first direction, and the first direction may be a vertical direction; and one of the ink pad assembly and the maintenance base may be provided with a guide groove, the other may be provided with a guide rod, and the guide rod may be slidably inserted into the guide groove between the adsorption position and the release position; the guide groove may have a front end and a rear end arranged oppositely, and an angle between the first direction and a line connecting the front end and the rear end may be not less than 0° and not more than 90°.

The ink pad assembly may comprise: an ink pad holder, movably connected to the maintenance base between the adsorption position and the release position; and/or an ink suction module, connected to one side of the ink pad holder away from the maintenance base, where the ink suction module is formed with the adsorption groove.

The ink suction module may be detachably connected to the ink pad holder.

The ink pad assembly may further include: a guide member, where the guide member may include a first portion and a second portion; the first portion may be connected to an outer wall of the ink pad holder and may extend away from the ink pad holder along a second direction; one end of the second portion may be connected to an end of the first portion away from the ink pad holder, and the other end may protrude towards a side of the ink pad holder close to the adsorption groove in the first direction; the second portion may be used to abut against a side wall of the nozzle in the second direction, so as to drive the ink pad assembly to move from the release position to the adsorption position; and the second direction may be arranged at an angle to the first direction.

The ink stack may further include: a second reset member, with one end connected to the maintenance base and the other end connected to the ink suction module, where the second reset member may be used to generate a force, and the force may enable the ink suction module to move from the adsorption position to the release position.

The ink suction module may include: a mounting seat, connected to the ink pad holder; an ink pad body, connected to the mounting seat; an adsorption structure, arranged in the mounting seat; and/or an ink pad sealing ring, connected to the ink pad body and arranged on the periphery of the adsorption structure, where the ink pad sealing ring and the adsorption structure may enclose the adsorption groove.

Aspects described herein further relate to a printing device, including: a host; a nozzle connected to the host; and/or the ink stack as described above, where the maintenance base of the ink stack may be connected to the host.

### BRIEF DESCRIPTION OF THE DRAWINGS

The following briefly introduces the accompanying drawings. The accompanying drawings in the following description show only some examples of the present application.

FIG. 1 is a schematic structural diagram of a printing device;

FIG. 2 is a top view of an ink stack;

FIG. 3 is a schematic structural diagram of the ink stack;

FIG. 4 is a schematic diagram of modules of an ink stack control system;

FIG. 5 is a schematic structural diagram of an ink pad assembly;

FIG. 6 is a schematic diagram of a control method for a plug in;

FIG. 7 is a schematic structural diagram of a maintenance base;

FIG. 8 is a schematic structural diagram of a scraper assembly; and

FIG. 9 is a left view of the scraper assembly.

In the figures: 10. Host; 20. Nozzle;
30. Ink stack; 31. Maintenance base; 311. Guide groove; 3111. Front end; 3112. Rear end;
32. Ink pad assembly; 321. Adsorption groove; 322. Ink pad holder; 3221. Guide member; 3222. First portion; 3223. Second portion; 3224. Guide wheel; 3225. Avoidance groove; 3226. First rotating shaft; 3227. Foam rack; 3228. Foam; 323. Ink suction module; 3231. Mounting seat; 3232. Ink pad body; 3233. Ink pad sealing ring; 3234. Adsorption structure; 3235. Ink suction foam; 3236. Ink pad filter; 324. Guide rod; 33. Buckle; 34. Clamping groove;
33. Vent tube;
34. Air-tight member; 341. Plug; 342. First driving assembly; 343. Driving module; 344. First connector; 3441. First end; 3442. Second end;
35. Scraper assembly; 351. Scraper support; 352. Scraper body; 353. Second connector; 354. First reset member;
36. Second driving assembly; 361. Third connector;
37. Second reset member;
38. Air pump; 381. Exhaust tube;
39. Main control board; 391. Air pressure detection module;
a. First direction; b. Second direction.

### DETAILED DESCRIPTION

Examples of the present application are described below with reference to the accompanying drawings therein. The described examples are merely some of the examples of the present application, not all of them.

In the description of the present application, an orientation or positional relationship indicated by the term(s) “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” or the like may be based on the orientation or positional relationship shown in the accompanying drawings and may be merely for ease of describing the present application and simplifying the description. These terms do not indicate or imply that an apparatus or an element referred to must have a specific orientation or be constructed and operated in a specific orientation. In addition, the terms “first” and “second” are merely used for a description purpose, and should not be interpreted as indicating or implying relative importance or implicitly indicating the quantity of the indicated technical features. Therefore, a feature defined by “first” or “second” may explicitly or implicitly include one or more features. The term “a plurality of” means two or more, unless otherwise specified. It should be noted that, unless otherwise specified and limited, the terms “mounted,” “connected,” and “connection” should be understood in a broad sense, for example, the “connection” may be fixed connection, detachable connection, integral connection, mechanical connection, electrical connection, direct connection, connection by a medium, or internal communication between two elements.

The term “exemplary” is used to indicate “used as an example, illustration, or demonstration”. Any example described as “exemplary” in the present application may not necessarily be interpreted as more preferred or advantageous than other examples. In the following description, details are listed for the purpose of explanation. The present application may be also implemented without using these specific details. Therefore, the present application is not limited to the shown examples, but is consistent with the widest scope of principles and features disclosed in the present application.

An ink stack may be one of the important components of a printing device, and the printing device may have a nozzle. When the ink stack comes into contact with the nozzle, the ink stack may completely cover the nozzle. The ink stack may be connected to an air pump to suck ink in the nozzle, so as to prevent the ink in the nozzle from coagulating on its surface to block the nozzle.

After the ink stack is aligned with the nozzle, the air pump may generate negative pressure at a cooperating position between the ink stack and the nozzle during operation. When the negative pressure changes, the nozzle may be prone to damage due to unstable or excessive pressure.

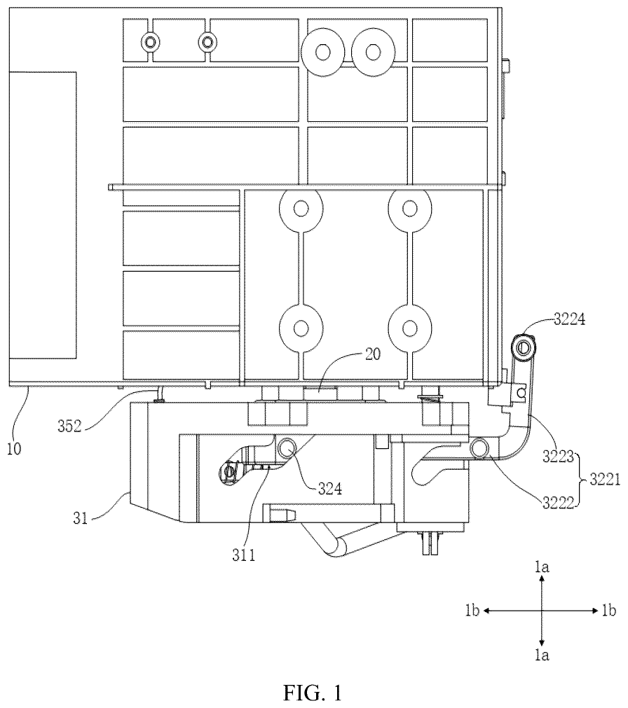

With reference to FIG. 1, an example of the present application provides an ink stack 30 used for a printing device. The ink stack 30 may cooperate with a nozzle 20 of the printing device. Pressure may be relieved from an adsorption groove 321 on an ink pad assembly 32 through a vent tube 33, so as to control the adsorption pressure of the ink stack 30 on the nozzle 20 and reduce damage to the nozzle 20 due to unstable or excessive pressure, where the vent tube 33 is arranged on the ink stack 30, and the adsorption groove 321 may be used to adsorb the nozzle 20.

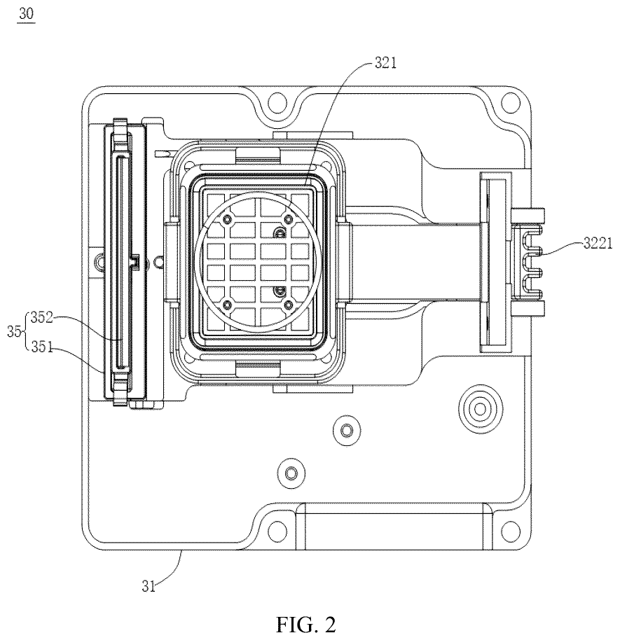

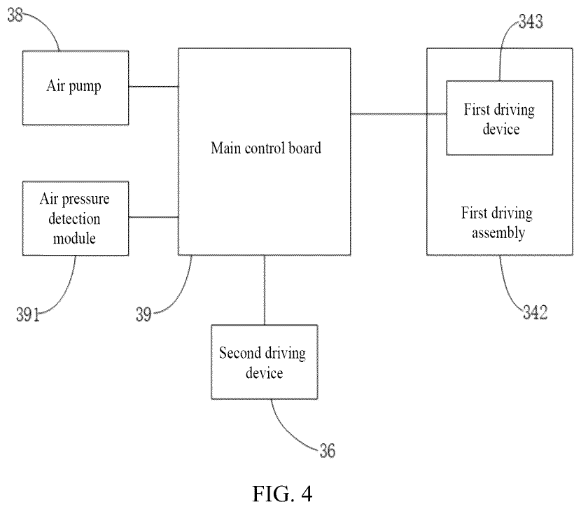

With reference to FIGS. 2, 3, and 4, in some examples, the ink stack 30 may include a maintenance base 31, an ink pad assembly 32, an air pump 38, and/or a vent tube 33.

The maintenance base 31 may serve as a support structure for the ink stack 30, or the maintenance base 31 may be connected to other functional components of the printing device for fixing the ink stack 30. The maintenance base 31 may be partially hollow to accommodate other functional components of the ink stack 30. The maintenance base 31 may be fixedly connected to other functional components of the printing device, and/or the maintenance base 31 may be detachably connected to other functional components of the printing device. The maintenance base 31 may face an upper part of the printing device, and the maintenance base 31 may be arranged below the nozzle 20. The maintenance base 31 may have a generally rectangular structure, or the maintenance base 31 may have an irregular-shaped structure to fully utilize the internal space of the printing device.

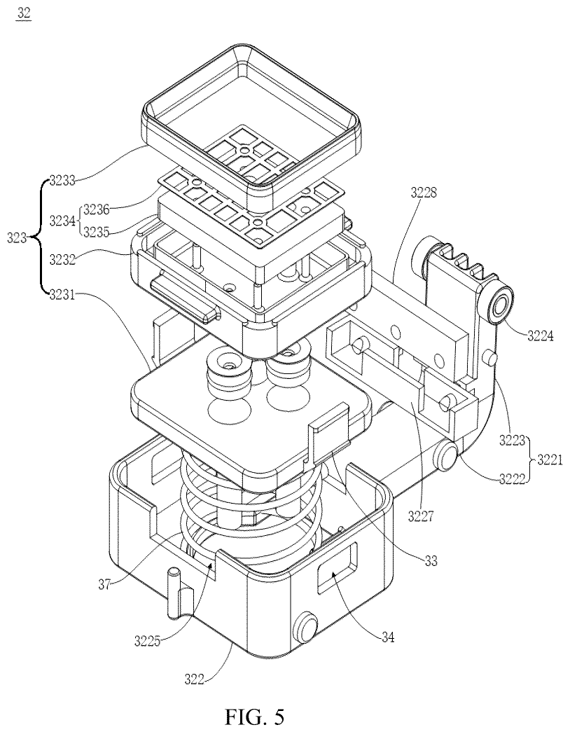

With reference to FIGS. 5 and 7, the ink pad assembly 32 may be mounted on the maintenance base 31, the ink pad assembly 32 may have an adsorption groove 321, and the adsorption groove 321 may be used to adsorb the nozzle 20.

The ink pad assembly 32 may be detachably connected to the maintenance base 31. The ink pad assembly 32 may be movably connected to the maintenance base 31, and the ink pad assembly 32 may move towards or away from the maintenance base 31, so that the ink pad assembly 32 may approach or move away from the nozzle 20. In some examples, the ink pad assembly 32 and the maintenance base 31 may be movably connected to the printing device together to change the distance between the ink pad assembly 32 and the nozzle 20 as needed.

The ink pad assembly 32 may have an adsorption groove 321, and the adsorption groove 321 may be used to adsorb liquid in the nozzle 20. The adsorption groove 321 may be used to accommodate the nozzle 20 when needed, so that the nozzle 20 may be confined to a position corresponding to the ink stack 30 on the printing device. The adsorption groove 321 may be used to cooperate with the nozzle 20. When the nozzle 20 is tightly attached to the adsorption groove 321, an inner wall surface of the adsorption groove 321 may be used to adsorb and seal the nozzle 20, so as to prevent ink coagulation from blocking the nozzle 20. The shape of the adsorption groove 321 may correspond to the shape of the nozzle 20, the adsorption groove 321 may have a generally concave shape, and/or the nozzle 20 may at least partially extend into the adsorption groove 321, so that the inner wall surface of the adsorption groove 321 may be attached to the nozzle 20 in a sealing manner.

The air pump 38 may be connected to the adsorption groove 321, an air inlet of the air pump 38 may be connected to the adsorption groove 321, an air outlet of the air pump 38 may be connected to the outside of the adsorption groove 321, and/or the air pump 38 may be used to suck gas in the adsorption groove 321, so that a local negative pressure state may be generated in the adsorption groove 321. The air inlet of the air pump 38 may be connected to the adsorption groove 321 through an exhaust tube 381. The exhaust tube 381 may be connected to any position of the adsorption groove 321. When the nozzle 20 is located in the adsorption groove 321, the air pump 38 may be opened to form negative pressure between the nozzle 20 and the inner wall surface of the adsorption groove 321. The air pump 38 may be mounted on the maintenance base 31 or the ink pad assembly 32. The air pump 38 may be mounted on other parts of the printing device. The air outlet of the air pump 38 may be connected to any position outside the adsorption groove 321. The air outlet of the air pump 38 may be connected to the outside of the ink stack 30. The ink pad assembly 32 may be provided with a through hole, the through hole may be connected to the adsorption groove 321, and the through hole may be connected to the air pump 38 through the exhaust tube 381. the quantity of the exhaust tube 381 may be one or more. When a plurality of exhaust tubes 381 are provided, the exhaust tubes 381 may be connected to a plurality of parts of the adsorption groove 321, so as to disperse the force acting on the nozzle 20 and reduce damage to the nozzle 20 due to uneven local force.

The vent tube 33 may be connected to the exhaust tube 381, and the vent tube 33 may be used to connect the exhaust tube 381 with the atmosphere.

The vent tube 33 may have a hollow structure, and the vent tube 33 may be used to connect the exhaust tube 381 with the outside of the ink pad assembly 32, so as to relieve pressure from the adsorption groove 321. When the nozzle 20 is adsorbed in the adsorption groove 321, the vent tube 33 may be used to adjust the negative pressure between the nozzle 20 and the inner wall surface of the adsorption groove 321. The vent tube 33 may be used to adjust the adsorption pressure between the adsorption groove 321 and the nozzle 20. When the air pump 38 operates, and when the inner wall surface of the adsorption groove 321 provides excessive adsorption pressure for the nozzle 20, the vent tube 33 may be used to reduce the pressure between the adsorption groove 321 and the nozzle 20, so as to reduce the risk of damage to the nozzle 20 due to excessive adsorption force. When the air pressure of the air pump 38 on the printing device is unstable, the vent tube 33 may also be used to stabilize the air pressure between the inner wall surface of the adsorption groove 321 and the nozzle 20, so as to reduce damage to the nozzle 20 due to unstable air pressure. The vent tube 33 may be connected to any part outside the ink pad assembly 32, and/or the vent tube 33 may be connected to any position on the outer side of the ink stack 30, so that the vent tube may be connected to the atmosphere. The vent tube may be connected to the atmosphere, indicating that air may flow between the exhaust tube and the external atmosphere via the vent tube.

When the air pump 38 operates and the power and other factors of the air pump 38 are constant, the air input of the air pump 38 may be constant. The air input of the air pump 38 may be dispersed by the vent tube 33, so as to change the negative pressure between the inner wall surface of the adsorption groove 321 and the nozzle 20. The air input of the vent tube 33 per unit time may be changed by adjusting at least one of the diameter of the vent tube 33, the quantity of the vent tube 33, and the opening of the vent tube 33. The ink stack 30 may further include an air pressure detection module 391 and a main control board 39, the air pressure detection module 391 may be used to detect the air pressure between the inner wall surface of the adsorption groove 321 and the nozzle 20, and the main control board 39 may be used to receive air pressure signals and control the opening of the vent tube 33 based on the air pressure signals.

One end of the vent tube 33 may be connected to any position of the exhaust tube 381. The quantity of the vent tube 33 may be plural, and the vent tubes 33 may be connected to different parts of the adsorption groove 321. When the ink pad assembly 32 is provided with a plurality of exhaust tubes 381, the quantity of vent tubes 33 may correspond to the quantity of exhaust tubes 381, and/or one vent tube 33 may be connected to a plurality of exhaust tubes 381.

Pressure may be relieved from the adsorption groove 321 through the vent tube 33, facilitating the control on the air pressure between the inner wall surface of the adsorption groove 321 and the nozzle 20, reducing damage to the nozzle 20 due to excessive or unstable air pressure, and prolonging the service life of the nozzle 20.

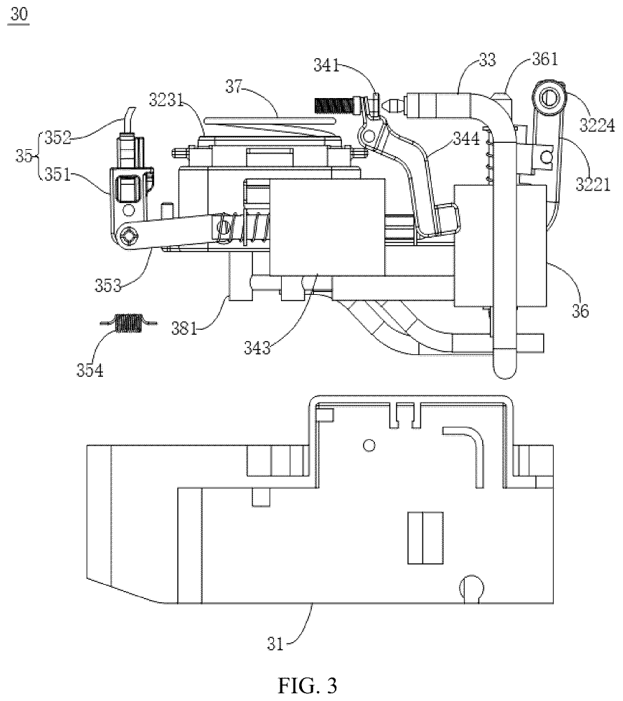

With reference to FIGS. 3, 4, and 6, the ink stack 30 may further include an air-tight member 34, the air-tight member 34 may be connected to the vent tube 33, and the air-tight member 34 may be used to open or close the vent tube 33.

The air-tight member 34 may be used to control the opening or closing of the vent tube 33, including controlling the opening or closing time of the vent tube 33 and the opening of the vent tube 33. The air-tight member 34 may have an open state and a closed state. When the air-tight member 34 is in the open state, the vent tube 33 may be fully opened. When the air-tight member 34 is in the closed state, the vent tube 33 may be fully closed. When the air-tight member 34 is between the open state and the closed state, the vent tube 33 may be partially opened. The air-tight member 34 may be arranged inside the vent tube 33, and the air-tight member 34 may be a gas valve or plug arranged inside the vent tube 33; and/or the air-tight member 34 may be arranged outside the vent tube 33. The air-tight member 34 in this example may be driven by a mechanical structure, or the air-tight member 34 may be an electrically driven structure such as an electromagnetic valve.

The ink stack 30 may further include a main control board 39, the main control board 39 may be electrically connected to the air pump 38, and the main control board 39 may be used to obtain working signals of the air pump 38; the main control board 39 might also electrically connected to the air-tight member 34, and the main control board 39 might also used to control the work of the air-tight member 34 based on the working signals of the air pump 38.

The main control board 39 described in this example may be a circuit board mounted on the maintenance base 31 or the ink pad assembly 32, and/or the main control board 39 may be mounted at other positions of the printing device. The main control board 39 may be electrically connected to the air pump 38, indicating that the main control board 39 may transmit electrical signals to the air pump 38. the main control board 39 may also be used to send electrical signals to the air pump 38, so as to control the opening or closing of the air pump 38 or the power of the air pump 38. The main control board 39 may also be used to obtain working signals of the air pump 38, where the working signals may include electrical signals such as the opening time or closing time of the air pump 38 and the operating power of the air pump 38. The main control board 39 may be also electrically connected to the air-tight member 34, indicating that the main control board 39 may send electrical signals to the air-tight member 34 to control the work of the air-tight member 34. The main control board 39 may also be used to send opening and closing time signals to the air-tight member 34, and the main control board 39 may also be used to send electrical signals to the air-tight member 34 to control the opening of the vent tube 33.

The main control board 39 may obtain the working signals of the air pump 38, and the main control board 39 may control the work of the air-tight member 34 based on the working state of the air pump 38. When the air pump 38 operates, the main control board 39 may control the air-tight member 34 to open, so that the vent tube 33 may be used for pressure relief.

The air-tight member 34 may include a plug 341 and a first driving assembly 342, the plug 341 may have an open position and a closed position, the open position may be used for opening the vent tube 33, and the closed position is used for closing the vent tube 33; the first driving assembly 342 may be connected to the plug 341, the main control board 39 may be electrically connected to the first driving assembly 342, and/or the main control board 39 may be used to control the movement of the first driving assembly 342, so as to drive the plug 341 to move between the open position and the closed position.

The plug 341 may be movably connected to the vent tube 33 between the open position and the closed position. The plug 341 may be movably arranged relative to the vent tube 33, so that the plug 341 may move between the open position and the closed position. When the plug 341 is in the open position, there may be a gap between the plug 341 and the vent tube 33, and air may flow through the vent tube 33. When the air pump 38 operates, the air input of the air pump 38 may be dispersed by the vent tube 33 to change the negative pressure between the inner wall surface of the adsorption groove 321 and the nozzle 20, so as to adjust the negative pressure adsorption force on the nozzle 20. The gap between the plug 341 and the vent tube 33 may be adjusted by adjusting the relative position of the plug 341, thereby adjusting the air flow rate of the vent tube 33. As the air flow rate of the vent tube 33 changes, the negative pressure adsorption force on the nozzle 20 might also change, which may balance the force on the nozzle 20. The ink stack 30 may further include the air pressure detection module 391, the air pressure detection module 391 may be used to detect the air pressure between the inner wall surface of the adsorption groove 321 and the nozzle 20, and the main control board 39 may be used to receive air pressure signals and control the position of the plug 341 based on the air pressure signals, thereby adjusting the gap between the plug 341 and the vent tube 33 to adjust the air flow rate of the vent tube. When the plug 341 is in the closed position, the plug 341 closes the vent tube 33, so that the vent tube 33 is closed.

The plug 341 may be movably connected to the vent tube 33. The plug 341 may be movably connected to the ink pad assembly 32, and the plug 341 may be rotatably or slidably connected to the ink pad assembly 32, so that the plug 341 may move between the open position and the closed position. The plug 341 may be directly slidably or rotatably connected to the maintenance base 31.

The first driving assembly 342 may be used to drive the plug 341 to move between the open position and the closed position, and the first driving assembly 342 may be used to drive the plug 341 to move along a preset trajectory. The first driving assembly 342 in this example may be a motor, an electromagnetic driving assembly, and/or other assemblies that may be used to drive the plug 341 to move along the preset trajectory.

The first driving assembly 342 may be electrically connected to the main control board 39, so that the main control board 39 may send control signals to the first driving assembly 324 to control the start, stop, and operation duration of the first driving assembly 342.

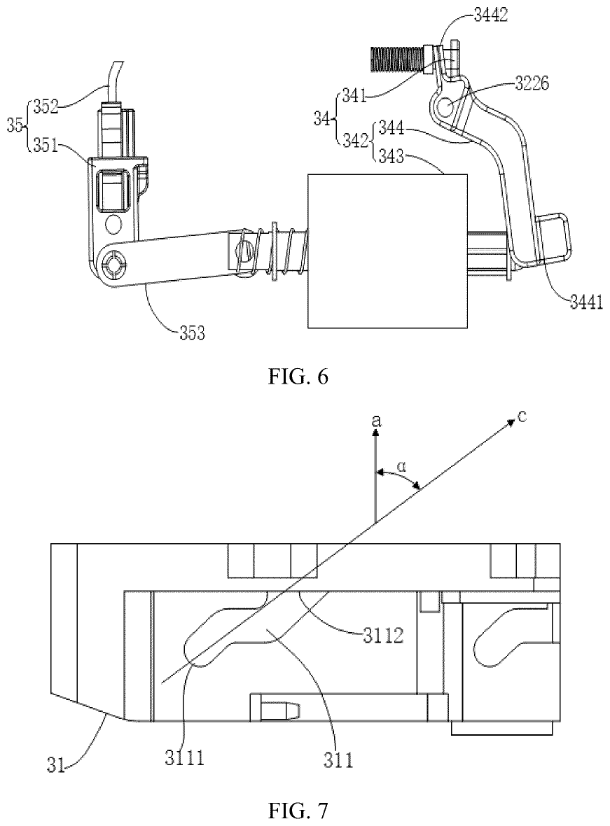

With reference to FIG. 6, the first driving assembly 342 may include a first connector 344 and a driving module 343; the first connector 344 may be connected to the plug 341; the driving module 343 may be connected to the ink pad assembly 32; the driving module 343 may have an output end, the output end of the driving module 343 may be connected to the first connector 344 in a driving manner, and the driving module 343 may be used to drive the first connector 344 to move the plug 341 between the open position and the closed position.

The first connector 344 may be connected to the plug 341, and the first connector 344 may be movably arranged relative to the vent tube 33 to drive the plug 341 to move synchronously.

The driving module 343 may be connected to the ink pad assembly 32, indicating that the driving module 343 may be fixedly or detachably connected to the ink pad assembly 32. The driving module 343 may be connected to the first connector 344 in a driving manner, indicating that the driving module 343 may drive the first connector 344 to move along the preset trajectory. The first connector 344 may serve as an intermediate connector between the driving module 343 and the plug 341. The first connector 344 may be rod-like, sheet-like, or other irregular shaped structures. The first connector 344 may be mounted in an area between the driving module 343 and the plug 341. On the one hand, the plug 341 may better adapt to the vent tube 33. On the other hand, the position of the driving module 343 may be determined as needed, so as to fully utilize the space inside the ink stack 30 and improve the rationality of spatial layout of components inside the ink stack 30.

The driving module 343 may be used to drive the first connector 344 to translate, rotate, or translate and rotate relative to the ink pad assembly 32. the first connector 344 is connected to the plug 341. When the driving module 343 drives the first connector 344 to move along the preset trajectory, the plug 341 may move synchronously, so that the plug 341 may move between the open position and the closed position. The driving module 343 may be a driving motor or other driving device. In some examples, the driving module 343 may be an electromagnetic driving device.

The first connector 344 may be rotatably connected to the ink pad assembly 32, and the driving module 343 may be used to drive the first connector 344 to rotate relative to the ink pad assembly 32.

The first connector 344 may rotate relative to the ink pad assembly 32. When the first connector 344 rotates, the plug 341 may move synchronously, so that the plug 341 may move between the open position and the closed position. The driving module 343 may drive the first connector 344 to rotate relative to the ink pad assembly 32 through gear engagement or other engagement methods. The first connector 344 may be rotatable relative to the ink pad assembly 32, facilitating the installation of the first connector 344 and the ink pad assembly 32. On the one hand, the ink pad assembly 32 may be used to support the first connector 344, so that the first connector 344 may have a relatively stable movement trajectory. On the other hand, the structural stability of the first connector 344 may be improved.

With reference to FIG. 6, the first connector 344 may have a first end 3441 and a second end 3442 arranged oppositely, the driving module 343 is connected to the first end 3441 in a driving manner, and the plug 341 is connected to the second end 3442; the ink pad assembly 32 may be provided with a first rotating shaft 3226, the first connector 344 may be rotatably connected to the first rotating shaft 3226, and the first rotating shaft 3226 may be connected between the first end 3441 and the second end 3442.

The first end 3441 and the second end 3442 may be two ends of the first connector 344 in a length direction. The first end 3441 of the first connector 344 may be rotatably connected to the driving module 343, so that the driving module 343 may drive the first connector 344 to rotate relatively. The plug 341 may be connected to the second end 3442. When the first connector 344 rotates relatively, the plug 341 may switch between the open position and the closed position. by connecting the plug 341 to the second end 3442, the travel of the plug 341 may be extended to control the opening of the vent tube 33 by controlling the position of the plug 341 relative to the vent tube 33.

The first rotating shaft 3226 may be a cylindrical structure, the cylindrical structure may be arranged on the ink pad assembly 32, and the first connector 344 may be rotatably connected to the first rotating shaft 3226, so that the first connector 344 may rotate relative to the ink pad assembly 32. The first rotating shaft 3226 may be arranged between the first end 3441 and the second end 3442, for example, the first rotating shaft 3226 may be arranged at a geometric center of an area between the first end 3441 and the second end 3442, or the first rotating shaft 3226 may be arranged near the first end 3441 or the second end 3442. the first rotating shaft 3226 cooperates with the first connector 344 to limit the first connector 344, so as to improve the stability of the first connector 344.

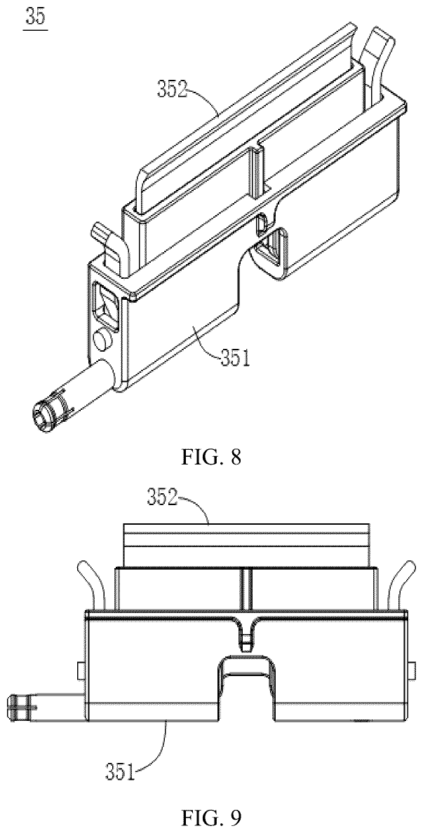

With reference to FIGS. 8 and 9, the ink stack 30 may further include a scraper assembly 35 and/or a second connector 353, the scraper assembly 35 may have a first position and a second position, and the scraper assembly 35 may be movably connected to the ink pad assembly 32 between the first position and the second position; the second connector 353 may be connected to the scraper assembly 35; the first driving assembly 342 may also be connected to the second connector 353 in a driving manner, and the first driving assembly 342 may also be used to drive the second connector 353 to move the scraper assembly 35 between the first position and the second position.

The scraper may be used to scrape excess ink from the nozzle 20. The scraper assembly 35 may be arranged beside the adsorption groove 321. During the movement of the nozzle 20, the scraper assembly 35 may be used to clean the nozzle 20.

The scraper assembly 35 may be movably connected to the ink pad assembly 32 between the first position and the second position, so that the angle and/or position of the scraper assembly 35 may be changed.

The scraper assembly 35 may comprise a scraper support 351 and/or a scraper body 352, where the scraper support 351 may be movably connected to the ink pad assembly 32; and the scraper body 352 may be connected to the scraper support 351. The scraper support 351 may be connected to the ink pad assembly 32, the scraper support 351 may serve as a main structure of the scraper assembly 35, the scraper support 351 may be provided with a clamping groove, the clamping groove may be used for mounting the scraper body 352, and the scraper body 352 may be clamped onto the scraper support 351. The scraper body 352 may be arranged as a quick disassembly structure, facilitating the replacement of the scraper body 352 as needed.

The first driving assembly 342 may comprise the first connector 344 and/or the driving module 343, the second connector 353 may serve as an intermediate connector between the scraper assembly 35 and/or the driving module 343, and the second connector 353 may be rod-like, disc-like, or other irregular shaped structures. The driving module 343 may be connected to the second connector 353 in the driving manner, so that the driving module 343 may drive the second connector 353 to move along the preset trajectory. The second connector 353 may slide, rotate, or slide and rotate relative to the ink pad assembly 32. The driving module 343 may drive the first connector 344 and the second connector 353 synchronously. Taking the state shown in FIG. 6 as an example, when the driving module 343 drives the first connector 344 to move and the plug 341 is in the open position accordingly, the driving module 343 may drive the second connector 353 synchronously, so that the scraper assembly 35 is in the first position, at this time, the scraper body 352 of the scraper assembly 35 may be used to scrape off the ink on the nozzle 20; and when the driving module 343 drives the first connector 344 to move and the plug 341 moves to the closed position accordingly, the driving module 343 may drive the scraper assembly 35 synchronously to move to the second position, the scraper body 352 of the scraper assembly 35 may be offset from the movement path of the nozzle 20, and the scraper assembly 35 need not contact the nozzle 20.

The driving module 343 may drive the scraper assembly 35 and the plug 341 to move, for example, a single driving device may be used to drive the state adjustment of two components, simplifying the structure of the ink stack 30 and improving the space utilization of the ink stack 30.

The ink stack 30 may further include a scraper assembly 35, a second connector 353, and/or a driving module 343, where the scraper assembly 35 may have a first position and a second position, and the scraper assembly 35 may be movably connected to the ink pad assembly 32 between the first position and the second position; the second connector 353 may be connected to the scraper assembly 35; the driving module 343 may be connected to the ink pad assembly 32, and the driving module 343 may be connected to the second connector 353 in a driving manner and may be used to drive the second connector 353 to move the scraper assembly 35 between the first position and the second position.

The driving module 343 may drive the scraper assembly 35 to move through the second connector 353, thereby adjusting the state of the scraper assembly 35.

The scraper assembly 35 may be rotatably connected to the ink pad assembly 32. One of the ink pad assembly 32 and the scraper assembly 35 may be provided with a rotating shaft, and the scraper assembly 35 may be rotatably connected to the ink pad assembly 32 through the rotating shaft. the scraper assembly 35 may rotatably switch between the first position and the second position, so that the position of the scraper assembly 35 may be adjusted. The rotating shaft may be connected to one end of the scraper assembly 35, or the rotating shaft may be arranged at a middle position of the scraper assembly 35.

With reference to FIG. 3 again, the ink stack 30 may further comprise a first reset member 354, one end of the first reset member 354 may be connected to the ink pad assembly 32, the other end may be connected to the second connector 353 or the scraper assembly 35, the first reset member 354 may be used to generate a force, and the force may enable the scraper assembly 35 to move from the first position to the second position.

The driving module 343 may be used to drive the scraper assembly 35 to move from the second position to the first position, so as to adjust the state of the scraper assembly 35. The first reset member 354 may be used to reset the scraper assembly 35, so that the scraper assembly 35 may move to the second position. When the scraper assembly 35 is in the first position, the plug 341 may be in an open state, and when the scraper assembly 35 is in the second position, the plug 341 may be in a closed state. The first reset member 354 may be a spring or other structure that may deform under force and restore its original state when the force disappears.

One end of the first reset member 354 may be connected to the ink pad assembly 32, and the other end may be connected to the scraper assembly 35, so that the first reset member 354 directly acts on the scraper assembly 35 and the scraper assembly 35 moves towards the second position. The other end of the first reset member 354 may be connected to the second connector 353, so that the first reset member 354 acts on the second connector 353 and the second connector 353 drives the scraper assembly 35 to move towards the second position.

The ink pad assembly 32 may have an adsorption position for adsorbing the nozzle 20 and a release position for releasing the nozzle 20, and the ink pad assembly 32 may be movably connected to the maintenance base 31 between the adsorption position and the release position.

The ink pad assembly 32 may be movably connected to the maintenance base 31, indicating that the ink pad assembly 32 may move relative to the maintenance base 31, so that the ink pad assembly 32 may move between the adsorption position and the release position. When the ink pad assembly 32 is in the adsorption position, the adsorption groove 321 may correspond to the nozzle 20, and the nozzle 20 may be adsorbed through the adsorption groove 321; and when the ink pad assembly 32 is in the release position, the adsorption groove 321 may be spaced apart from the nozzle 20, so that the nozzle 20 may be detached from the adsorption groove 321.

The ink pad assembly 32 may slide relative to the maintenance base 31, and the ink pad assembly 32 may move relative to the maintenance base 31 along a straight line, a curve, or a straight line and a curve. The ink pad assembly 32 may move relative to the maintenance base 31, so that the ink pad assembly 32 may be adapted to the nozzle 20 to adsorb the nozzle 20. When the nozzle 20 does not need to be adsorbed, the nozzle 20 may be promptly detached from the adsorption groove 321. A driving device may drive the ink pad assembly 32 to move relative to the maintenance base 31, where the driving device may be a motor or other driving structures.

With reference to FIG. 1 and FIG. 7 again, the ink pad assembly 32 and/or the maintenance base 31 may be provided with a guide groove 311, the other may be provided with a guide rod 324, and the guide rod 324 may be slidably inserted into the guide groove 311 between the adsorption position and the release position.

The guide rod 324 may be at least partially inserted into the guide groove 311, and the guide rod 324 may move along a trajectory formed by the guide groove 311. When the guide rod 324 moves within the guide groove 311, the ink pad assembly 32 may move relative to the maintenance base 31 between the adsorption position and the release position.

The guide groove 311 may be used to define the movement trajectory of the guide rod 324, and the extension direction of the guide groove 311 is consistent with the movement trajectory of the ink pad assembly 32 from the adsorption position to the release position. The guide rod 324 in this example may be arranged on the ink pad assembly 32, and the guide groove 311 may be arranged on the maintenance base 31, or the guide rod 324 may be arranged on the maintenance base 31, and the guide groove 311 may be arranged on the ink pad assembly 32. For example, the guide rod 324 may be connected to the ink pad assembly 32, and the guide groove 311 may be a groove formed on the maintenance base 31.

When the ink pad assembly 32 moves relative to the maintenance base 31, the guide groove 311 may limit the movement trajectory of the guide rod 324, so that the ink pad assembly 32 might move only along the trajectory formed by the guide groove 311, thereby improving the stability of the ink pad assembly 32 during movement, reducing unnecessary shaking of the ink pad assembly 32 during movement between the adsorption position and the release position, and/or reducing the possibility of misalignment between the ink pad assembly 32 and the nozzle 20.

With continued reference to FIG. 1, the ink pad assembly 32 may be at least partially arranged on one side of the maintenance base 31 along a first direction a, and the adsorption groove 321 may be located on one side of the ink pad assembly 32 away from the maintenance base 31 along the first direction a; the guide groove 311 may have a front end 3111 and a rear end 3112 arranged oppositely, and an angle α between the first direction a and a line c connecting the front end 3111 and the rear end 3112 may be not less than 0° and not more than 90°.

The first direction a may be from bottom to top, and the ink pad assembly 32 may be at least partially arranged above the maintenance base 31. The adsorption groove 321 may be arranged away from the maintenance base 31, so that the adsorption groove 321 may be used to adapt to the nozzle 20.

The front end 3111 and the rear end 3112 of the guide groove 311 may be two ends of the guide groove 311 in the length direction. The front end 3111 and the rear end 3112 of the guide groove 311 are connected by a line, and the angle α between the obtained connecting line c and the first direction a is not less than 0°, indicating that the guide rod 324 need not move linearly along the first direction a; and the angle α between the connecting line c and the first direction a might be not more than 90°, indicating that the guide rod 324 need not move in a direction perpendicular to the first direction a. For example, the ink pad assembly 32 may be arranged above the maintenance base 31, the front end 3111 of the adsorption groove 321 may be inclined upward towards the rear end 3112, and the guide rod 324 may move away from the maintenance base 31 along the inclined upward direction inside the adsorption groove 321. The guide groove 311 may be partially inclined upward, partially horizontally or vertically. The overall extension direction of the guide groove 311 may be inclined, so that the ink pad assembly 32 may move relative to the maintenance base 31 in an overall inclined upward manner.

With reference to FIG. 5 again, the ink pad assembly 32 may include an ink pad holder 322 and/or an ink suction module 323, where the ink pad holder 322 may be movably connected to the maintenance base 31 between the adsorption position and the release position; the ink suction module 323 may be connected to one side of the ink pad holder 322 away from the maintenance base 31; and the ink suction module 323 may be formed with the adsorption groove 321.

The ink pad holder 322 may serve as a bottom support structure of the ink pad assembly 32, and the ink pad holder 322 may move relative to the maintenance base 31. When the ink pad holder 322 moves relative to the maintenance base 31, the ink pad assembly 32 may move between the adsorption position and the release position. The ink pad holder 322 may be of a rectangular plate-like structure, and/or the ink pad holder 322 may be of a box-like structure that may be at least partially hollow, or the ink pad holder 322 may be of an irregular shaped structure.

The ink suction module 323 may be used to suck ink. The ink suction module 323 may be connected to the ink pad holder 322, and the ink pad holder 322 may support the ink suction module 323, so that the ink suction module 323 may move synchronously with the ink pad holder 322. The ink suction module 323 may be connected and/or fixed to the ink pad holder 322. The adsorption groove 321 as described in any of the above examples is formed on the ink suction module 323, and the adsorption groove 321 may be a groove on a side of the ink suction module 323 away from the ink pad holder 322. The ink stack 30 may include the exhaust tube 381, the ink pad holder 322 may be provided with a through hole connected to the adsorption groove 321, and the exhaust tube 381 may be connected to the corresponding through hole to generate negative pressure inside the adsorption groove 321. The ink suction module 323 may be located at least partially within the ink pad holder 322 to reduce the volume of the ink pad assembly 32. The ink pad holder 322 may be provided with a sunken groove, the ink suction module 323 may be embedded in the sunken groove, and the ink suction module 323 may be connected and fixed to the ink pad holder 322 by bolts, clamping, and/or other ways. The ink pad holder 322 may be integrated with the ink suction module 323 and may move synchronously between the release position and the adsorption position. The ink suction module 323 may be a quick disassembly structure on the ink pad holder 322. One of the ink pad holder 322 and the ink suction module 323 may be provided with a buckle 33, the other may be provided with a clamping groove 34, and the buckle 33 may be clamped into the clamping groove 34 to facilitate quick disassembly of the ink suction module 323 from the ink pad holder 322.

The ink pad assembly 32 may further include a guide member 3221, where the guide member 3221 may include a first portion 3222 and/or a second portion 3223; the first portion 3222 may be connected to an outer wall of the ink pad holder 322 and may extend away from the ink pad holder 322 along a second direction b; one end of the second portion 3223 may be connected to an end of the first portion 3222 away from the ink pad holder 322, and the other end may protrude towards a side of the ink pad holder 322 close to the adsorption groove 321 in the first direction a; the second portion 3223 may be used to abut against a side wall of the nozzle 20 in the second direction b, so as to drive the ink pad assembly 32 to move from the release position to the adsorption position; and the second direction b may be arranged at an angle to the first direction a.

The guide member 3221 may be connected to the ink pad holder 322. The guide member 3221 may be separated from and connected to the ink pad holder 322. The guide member 3221 may be integrated with the ink pad holder 322.

The guide member 3221 may include the first portion 3222 and the second portion 3223, and the first portion 3222 and the second portion 3223 may be interconnected to form a whole. The first portion 3222 may be connected to the outer wall of the ink pad holder 322, and the first portion 3222 may protrude and/or extend along the second direction b on the outer side of the ink pad holder 322. The second direction b may be arranged at an angle to the first direction a, indicating that the second direction b need not be parallel to the first direction a. The second direction b may be perpendicular to the first direction a. The second portion 3223 may be connected to the first portion 3222, and the second portion 3223 protrudes towards the outer side of the ink pad holder 322, so that the second portion 3223 may at least partially protrude from the outside of the ink pad holder 322 in the first direction a, and the end of the second portion 3223 away from the first portion 3222 may protrude towards the side close to the adsorption groove 321.

The adsorption groove 321 may be used to cooperate with the nozzle 20, the second portion 3223 may protrude towards one side of the adsorption groove 321, and when the nozzle 20 of the printing device moves towards the adsorption groove 321 along the second direction b, the side wall of the nozzle 20 in the second direction b may abut against the second portion 3223, so that the second portion 3223 may move synchronously, the second portion 3223 may drive the ink pad holder 322 to move synchronously, and the entire ink pad assembly 32 may move from the release position to the adsorption position. When the ink pad assembly 32 moves to the adsorption position, the adsorption groove 321 of the ink pad assembly 32 may align with the nozzle 20, so that the ink pad assembly 32 may be used to adsorb the nozzle 20. The maintenance base 31 and the ink pad assembly 32 may be limited by the guide rod 324 and the guide groove 311, and the ink pad assembly 32 might be configured to move only along the trajectory formed by the guide groove 311, so when the ink suction module 323 moves to the rear end 3112 of the guide groove 311, the adsorption groove 321 may adapt to the nozzle 20.

During the movement of the nozzle 20, the nozzle 20 may drive the second portion 3223 to move synchronously, and then the ink pad assembly 32 might move from the release position to the adsorption position. During the movement of the ink pad assembly 32, no driving device need be added, but the nozzle 20 may be used to drive the ink pad assembly 32 to move synchronously. On one hand, the driving complexity of the ink stack 30 may be reduced, and the structural design may be simplified. On the other hand, the driving mechanism may be reduced, and the driving cost may be lowered. On the further hand, because the nozzle 20 may drive the ink pad assembly 32 to move synchronously during movement, the nozzle 20 and the ink pad assembly 32 may be operated synchronously, improving the operation accuracy of the ink stack 30. the first portion 3222 and the second portion 3223 are provided, the second portion 3223 may be used to cooperate with the side wall of the nozzle 20 in the second direction b, and the first portion 3222 protrudes from the outside of the ink pad holder 322 to form an extension portion on the outside of the ink pad holder 322, so that the second portion 3223 may better misalign from the adsorption groove 321, the nozzle 20 may contact the second portion 3223 during the movement of the nozzle 20, and the second portion 3223 need not interfere with the nozzle 20 and the adsorption groove 321. When the nozzle 20 is in a state of mutual adsorption with the adsorption groove 321, the second portion 3223 might not be able to move relatively due to the obstruction of the side wall of the nozzle 20 in the second direction b, thereby preventing the ink pad assembly 32 from resetting towards the release position. When the nozzle 20 is detached from the adsorption groove 321, the force exerted by the nozzle 20 to the second portion 3223 may disappear, and the ink pad assembly 32 may move from the adsorption position to the release position.

A guide wheel 3224 may be provided at one end of the guide member 3221 away from the ink pad holder 322. The guide wheel 3224 may be used to rotatably abut against the side wall of the nozzle 20 in the second direction b. The rotatable abutment may indicate that the guide wheel 3224 may rotate relative to the side wall of the nozzle 20 in the second direction b, so as to reduce the frictional resistance between the side wall of the nozzle 20 in the second direction b and the second portion 3223. The guide wheel 3224 may be a rotatable structure such as a roller or a bearing.

A foam rack 3227 may be provided on a side of the second portion 3223 facing the adsorption groove 321, and foam 3228 may be placed on the foam rack 3227. When the nozzle 20 pushes the second portion 3223 to move, the foam 3228 may be used to adsorb ink on the nozzle 20.

The ink stack 30 may further include a second reset member 37, one end of the second reset member 37 may be connected to the maintenance base 31, the other end may be connected to the ink suction module 323, the second reset member 37 may be used to generate a force, and the force may enable the ink suction module 323 to move from the adsorption position to the release position. The second reset member 37 may be made of an elastic reset material, such as a spring. The second reset member 37 may be used to generate a force for the ink suction module 323, so as to drive the ink suction module 323 to move towards the release position. When the nozzle 20 and the adsorption groove 321 detach from each other, the force of the nozzle 20 on the second portion 3223 might disappear. Under the force of the second reset member 37, the ink suction module 323 may move towards the release position, so that the ink pad assembly 32 may restore to its original state. The second reset member 37 may be directly connected to the ink suction module 323 and the maintenance base 31. Because the ink suction module 323 may be integrated with the ink pad holder 322, the second reset member 37 may also be connected to the ink pad holder 322. The second reset member 37 may be connected to any position on the ink suction module 323, and the ink suction module 323 may be arranged on the periphery of the exhaust tube 381. The second reset member 37 may be used to generate a force in the first direction a for the ink suction module 323.

The ink pad holder 322 may be provided with an avoidance groove 3225, and the second reset member 37 may be inserted into the avoidance groove 3225. The avoidance groove 3225 may be a through hole, the ink pad holder 322 may be inserted into the through hole, and the second reset member 37 may be inserted into the avoidance groove 3225 and connected to the maintenance base 31. The avoidance groove 3225 may correspond to the geometric center of the ink pad holder 322 to balance the force on the ink suction module 323 and reduce the possibility of tilting of the ink suction module 323.

The ink suction module 323 may include a mounting seat 3231, an ink pad body 3232, an adsorption structure 3234, and/or an ink pad sealing ring 3233, where the mounting seat 3231 may be connected to the ink pad holder 322; the ink pad body 3232 may be connected to the mounting seat 3231; the adsorption structure 3234 may be arranged in the mounting seat 3231; the ink pad sealing ring 3233 may be connected to the ink pad body 3232 and arranged on the periphery of the adsorption structure 3234; and the ink pad sealing ring 3233 and the adsorption structure 3234 may enclose the adsorption groove 321.

The mounting seat 3231 may serve as a main support structure for the ink suction module 323, and the mounting seat 3231 may be connected to the ink pad holder 322. The mounting seat 3231 may be connected to the ink pad holder 322 by bolts, clamping or other ways. The mounting seat 3231 may be of a rectangular plate-like structure or other irregular shaped structures. The ink stack 30 may be provided with the second reset member 37, and the second reset member 37 may be connected to the mounting seat 3231. The mounting seat 3231 may be provided with a through hole, and the exhaust tube 381 may be connected to the through hole on the mounting seat 3231. One of the mounting seat 3231 and the ink pad holder 322 may be provided with the buckle 33, the other may be provided with the clamping groove 34, and the buckle 33 may be clamped into the clamping groove 34.

The ink pad body 3232 may be connected to the mounting seat 3231, and the ink pad body 3232 may be used to support the adsorption structure 3234, so as to keep the adsorption structure 3234 in a preset position on the ink pad holder 322.

The adsorption structure 3234 may be used to adsorb ink. The adsorption module may include an ink suction foam 3235 and an ink pad filter 3236, the ink pad filter 3236 may be arranged on a side of the ink suction foam 3235 away from the mounting seat 3231, and the ink suction foam 3235 and the ink pad filter 3236 may be connected to the ink pad body 3232 respectively.

The ink pad sealing ring 3233 may have a generally annular structure, and the ink pad sealing ring 3233 may correspond to the shape of the nozzle 20. The ink pad sealing ring 3233 may be connected to the ink pad body 3232, indicating that the ink pad sealing ring 3233 may be clamped onto the ink pad body 3232, and/or the ink pad sealing ring 3233 may be connected and fixed to the ink pad body 3232 by bolts and/or other ways. The ink pad sealing ring 3233 may be arranged on the periphery of the adsorption structure 3234, so that the ink pad sealing ring 3233 may form an annular sealing structure on the periphery of the adsorption structure 3234. The ink pad sealing ring 3233 and the adsorption structure 3234 may enclose the adsorption groove 321. When the nozzle 20 moves to the adsorption groove 321, the ink pad sealing ring 3233 may enclose the nozzle 20 to seal the gap between the nozzle 20 and the adsorption structure 3234.

The ink stack 30 may further include a third connector 361 and/or a second driving assembly 36, where the third connector 361 may have a connection position and a disconnection position; the second driving assembly 36 may be connected to the third connector 361 in a driving manner and used to drive the third connector 361 to move between the connection position and the disconnection position.

The second driving assembly 36 may be used to drive the third connector 361 to move along a preset trajectory, so that the third connector 361 may move between the connection position and the disconnection position. The movement trajectory of the third connector 361 may be a straight line, a curve, and/or a combination of a straight line and a curve. The second driving assembly 36 may be a motor, an electromagnetic driving device, and/or other devices that may drive the third connector 361 to move along the preset trajectory.

The second driving assembly 36 may be connected to the ink pad assembly 32, and the third connector 361 may be connected to the nozzle 20 at the connection position or disconnected from the nozzle 20 at the disconnection position; when the second driving assembly 36 drives the third connector 361 to move, the third connector 361 may be connected to the nozzle 20, so that the third connector 361 limits the nozzle 20 to prevent the ink pad assembly 32 from moving relative to the nozzle 20; and when the second driving assembly 36 drives the third connector 361 to move towards the disconnection position, the third connector 361 may move away from the nozzle 20, so that the nozzle 20 no longer exerts traction to the ink pad assembly 32 or the maintenance base 31. The second driving assembly 36 may be connected to the maintenance base 31.

The second driving assembly 36 may be connected to the nozzle 20, and the third connector 361 may be connected to the ink pad assembly 32 at the connection position or disconnected from the ink pad assembly 32 at the disconnection position. The second driving assembly 36 and the third connector 361 may be used to limit the nozzle 20 and the ink pad assembly 32. The third connector 361 may be connected to the maintenance base 31.

By providing the second driving assembly 36 and the third connector 361, the third connector 361 may be connected to the nozzle 20 and the ink pad assembly 32 and/or the maintenance base 31 when needed, so as to limit the positions of the ink pad assembly 32 and the nozzle 20 again, thereby improving the stability of cooperation between the nozzle 20 and the adsorption groove 321.

The present application further provides an example of a printing device, including a host 10, a nozzle 20, and/or the ink stack 30, where the nozzle 20 may be connected to the host 10; and the maintenance base 31 of the ink stack 30 may be connected to the host 10.

The host 10 may serve as a main structure of the printing device, and the nozzle 20 may be movably connected to the host 10, so that the nozzle 20 may carry out a printing operation along a preset trajectory. The adsorption groove 321 of the ink stack 30 may be arranged towards one side of the nozzle 20, so that the nozzle 20 may align with the adsorption groove 321 when needed. The printing device may further include other functional components, which may be referred to in relevant technologies.

The above are merely the examples of the present application and do not limit the patent scope of the present application. Any equivalent structure or equivalent process transformation made through the description and accompanying drawings of the present application, directly or indirectly applied in other related technical fields, is included in the scope of patent protection of the present application.

What is claimed is:

1. An ink stack used for a printing device, the printing device having a nozzle, wherein the ink stack comprises:
a maintenance base;
an ink pad assembly, mounted on the maintenance base, wherein the ink pad assembly has an adsorption groove, and wherein the adsorption groove is used to adsorb the nozzle;
an air pump, wherein the air pump is connected to the adsorption groove through an exhaust tube; and
a vent tube, connected to the exhaust tube, wherein the vent tube is used to connect the exhaust tube with the atmosphere.

2. The ink stack according to claim 1, wherein the ink stack further comprises:
a main control board, electrically connected to the air pump, wherein the main control board is used to obtain working signals of the air pump; and
an air-tight member, wherein the air-tight member is used to control an opening or closing of the vent tube, wherein the air-tight member is electrically connected to the main control board, and wherein the main control board is also used to control the work of the air-tight member based on the working signals of the air pump.

3. The ink stack according to claim 2, wherein the air-tight member comprises:
a plug, wherein the plug has an open position and a closed position, wherein the open position is used for opening the vent tube, and wherein the closed position is used for closing the vent tube; and
a first driving assembly, connected to the plug, wherein the main control board is electrically connected to the first driving assembly, and wherein the main control board is used to control movement of the first driving assembly so as to drive the plug to move between the open position and the closed position.

4. The ink stack according to claim 3, wherein the ink stack further comprises:
a scraper assembly, wherein the scraper assembly has a first position and a second position, and wherein the scraper assembly is movably connected to the ink pad assembly between the first position and the second position; and
a second connector, connected to the scraper assembly, wherein an output end of the first driving assembly is connected to the second connector in a driving manner, and wherein the first driving assembly is also used to drive the second connector to move the scraper assembly between the first position and the second position.

5. The ink stack according to claim 4, wherein the first driving assembly is used to drive the scraper assembly to move from the second position to the first position, and wherein the ink stack further comprises:
a first reset member with one end connected to the ink pad assembly and the other end connected to the second connector or the scraper assembly, wherein the first reset member is used to generate a force, and wherein the force enables the scraper assembly to move from the first position to the second position.

6. The ink stack according to claim 1, wherein:
the ink pad assembly is at least partially arranged on one side of the maintenance base along a first direction,
the adsorption groove is located on one side of the ink pad assembly away from the maintenance base along the first direction,
the first direction is a vertical direction,
one of the ink pad assembly and the maintenance base is provided with a guide groove, the other is provided with a guide rod,
the guide rod is slidably inserted into the guide groove between an adsorption position and a release position,
the guide groove has a front end and a rear end arranged oppositely, and
an angle between the first direction and a line connecting the front end and the rear end is not less than 0° and not more than 90°.

7. The ink stack according to claim 6, wherein the ink pad assembly comprises:
an ink pad holder movably connected to the maintenance base between the adsorption position and the release position; and
an ink suction module connected to one side of the ink pad holder away from the maintenance base, wherein the ink suction module is formed with the adsorption groove.

8. The ink stack according to claim 7, wherein the ink suction module is detachably connected to the ink pad holder.

9. The ink stack according to claim 7, wherein the ink pad assembly further comprises:
a guide member, wherein:
the guide member comprises a first portion and a second portion,
the first portion is connected to an outer wall of the ink pad holder and extends away from the ink pad holder along a second direction,
one end of the second portion is connected to an end of the first portion away from the ink pad holder,
the other end protrudes towards a side of the ink pad holder close to the adsorption groove in the first direction,
the second portion is used to abut against a side wall of the nozzle in the second direction so as to drive the ink pad assembly to move from the release position to the adsorption position, and
the second direction is arranged at an angle to the first direction.

10. The ink stack according to claim 7, wherein the ink stack further comprises:
a second reset member, with one end connected to the maintenance base and the other end connected to the ink suction module, wherein the second reset member is used to generate a force, and wherein the force enables the ink suction module to move from the adsorption position to the release position.

11. The ink stack according to claim 7, wherein the ink suction module comprises:
a mounting seat connected to the ink pad holder;
an ink pad body connected to the mounting seat;
an adsorption structure arranged in the mounting seat; and
an ink pad sealing ring connected to the ink pad body and arranged on a periphery of the adsorption structure, wherein the ink pad sealing ring and the adsorption structure enclose the adsorption groove.

12. A printing device, comprising:
a host;
a nozzle, connected to the host; and
an ink stack, wherein the ink stack comprises:
a maintenance base connected to the host;
an ink pad assembly, mounted on the maintenance base, wherein the ink pad assembly has an adsorption groove, and wherein the adsorption groove is used to adsorb the nozzle;
an air pump, wherein the air pump is connected to the adsorption groove through an exhaust tube; and
a vent tube, connected to the exhaust tube, wherein the vent tube is used to connect the exhaust tube with the atmosphere.

13. The printing device according to claim 12, wherein the ink stack further comprises:
a main control board, electrically connected to the air pump, wherein the main control board is used to obtain working signals of the air pump; and
an air-tight member, wherein the air-tight member is used to control an opening or closing of the vent tube, wherein the air-tight member is electrically connected to the main control board, and wherein the main control board is also used to control the work of the air-tight member based on the working signals of the air pump.

14. The printing device according to claim 13, wherein the air-tight member comprises:
a plug, wherein the plug has an open position and a closed position, wherein the open position is used for opening the vent tube, and wherein the closed position is used for closing the vent tube; and
a first driving assembly, connected to the plug, wherein the main control board is electrically connected to the first driving assembly, and wherein the main control board is used to control movement of the first driving assembly so as to drive the plug to move between the open position and the closed position.

15. The printing device according to claim 14, wherein the ink stack further comprises:
a scraper assembly, wherein the scraper assembly has a first position and a second position, and wherein the scraper assembly is movably connected to the ink pad assembly between the first position and the second position; and
a second connector, connected to the scraper assembly, wherein an output end of the first driving assembly is connected to the second connector in a driving manner, and wherein the first driving assembly is also used to drive the second connector to move the scraper assembly between the first position and the second position.

16. The printing device according to claim 15, wherein the first driving assembly is used to drive the scraper assembly to move from the second position to the first position, and wherein the ink stack further comprises:
a first reset member with one end connected to the ink pad assembly and the other end connected to the second connector or the scraper assembly, wherein the first reset member is used to generate a force, and wherein the force enables the scraper assembly to move from the first position to the second position.

17. The printing device according to claim 12, wherein:
the ink pad assembly is at least partially arranged on one side of the maintenance base along a first direction,
the adsorption groove is located on one side of the ink pad assembly away from the maintenance base along the first direction,
the first direction is a vertical direction,
one of the ink pad assembly and the maintenance base is provided with a guide groove,
the other is provided with a guide rod,
the guide rod is slidably inserted into the guide groove between an adsorption position and a release position,
the guide groove has a front end and a rear end arranged oppositely, and
an angle between the first direction and a line connecting the front end and the rear end is not less than 0° and not more than 90°.

18. The printing device according to claim 17, wherein the ink pad assembly comprises:
an ink pad holder movably connected to the maintenance base between the adsorption position and the release position; and
an ink suction module connected to one side of the ink pad holder away from the maintenance base, wherein the ink suction module is formed with the adsorption groove.

19. The printing device according to claim 18, wherein the ink suction module is detachably connected to the ink pad holder.

20. The printing device according to claim 18, wherein the ink pad assembly further comprises:
a guide member, wherein:
the guide member comprises a first portion and a second portion,
the first portion is connected to an outer wall of the ink pad holder and extends away from the ink pad holder along a second direction,
one end of the second portion is connected to an end of the first portion away from the ink pad holder,
the other end protrudes towards a side of the ink pad holder close to the adsorption groove in the first direction,
the second portion is used to abut against a side wall of the nozzle in the second direction so as to drive the ink pad assembly to move from the release position to the adsorption position, and
the second direction is arranged at an angle to the first direction.
